(19) United States
(12) Patent Application Publication
(10) Pub. No.: US 2002/0125081 A1
(43) Pub. Date: Sep. 12, 2002

(54) Lining backing plate

(76) Inventor: Kurt Meyer, Bunde (DE)

Correspondence Address: LERNER AND GREENBERG, P.A., POST OFFICE BOX 2480, HOLLYWOOD, FL, 33022-2480, US

(21) Appl. No.: 10/134,892

(22) Filed: Apr. 29, 2002

Related U.S. Application Data
(63) Continuation of application No. PCT/DE00/03787, filed on Oct. 26, 2000.

(30) Foreign Application Priority Data
Oct. 28, 1999 (DE) 299 18 991.0
Aug. 25, 2000 (DE) 200 14 721.8
Oct. 13, 2000 (DE) 200 17 539.4

(51) Int. Cl. F16D 65/00

(52) U.S. Cl. 188/73.1; 188/218 XL

(57) ABSTRACT

A backing plate of a disk brake pad is to be produced in an efficient and cost-effective manner and in such a way that the plate offers an increased operating safety. The support surface of the friction lining for improving the transverse strength or shear strength is at least partially provided with an indent area and a large part of the body edges of the indent area are surrounded by the friction lining which is formed on the support surface of the backing plate.

### CROSS-REFERENCE TO RELATED APPLICATION

This application is a continuation of copending International Application No. PCT/DE00/03787, filed Oct. 26, 2000, which designated the United States.

### BACKGROUND OF THE INVENTION

1. Field of the Invention

The invention pertains to a backing plate for a friction lining of a disk brake made up of a brake disk, a brake caliper having brake pistons, and brake pads. The brake pads are each made up of a lining backing plate consisting of a backing plate having a bearing surface for the friction lining and the friction lining, which is there formed from a hardened compound, and having guide surfaces or holding surfaces for mounting the backing plate in a brake caliper.

In prior art backing plates of disk brakes, as described, for example, in U.S. Pat. No. 4,924,583 to Hummel et al., it is known to weld expanded metal segments onto lining backing plates in order subsequently to apply a viscous friction lining compound thereon, which then hardens to form a solid lining and in this way is fixed on the lining backing plate. A disadvantage of this is the high manufacturing expense, as well as the testing, which is possible only in a destructive manner, of the quality of the connection between the stretched metal segments and the lining backing plate.

In addition, given excessive wear of a friction lining of a brake pad, there is the danger, in some known disk brakes, that a friction backing plate will slip out of a brake caliper. This, of course, represents a very great potential danger for a vehicle driver and for third parties.

In another type of disk brake pad, it is known to fix friction linings on a lining backing plate by gluing, as well as by the production of anchoring pegs that extend into bored holes of the lining backing plate. However, the temperatures that occur during braking can have the result that the adhesive burns, so that the anchoring of a brake lining is then further ensured only by the anchoring pegs, which however cannot accept any forces oriented perpendicular to the lining surface, so that the friction linings can loosen and lift slightly from the lining backing plate, whereupon the anchoring pegs can be torn off during a braking procedure by the shear forces that occur.

### SUMMARY OF THE INVENTION

It is accordingly an object of the invention to provide a backing plate for the friction lining of a disk brake, which overcomes the above-mentioned disadvantages of the heretofore-known devices and methods of this general type and can be manufactured effectively and economically and that offers increased operating safety. In particular, it should be possible to ensure a reliable, long-lasting anchoring of the friction lining on the lining backing plate, and of the lining backing plate in a brake caliper.

With the foregoing and other objects in view there is provided, in accordance with the invention, a backing plate for a friction lining of a disk brake pad, comprising:

a sheet-metal plate having a bearing surface for supporting the friction lining formed thereon from a hardened compound, and having guide and holding surfaces for mounting in a brake caliper of a disk brake;

said sheet-metal plate having at least one indent formed therein, for improving a shear strength of the friction lining on said bearing surface, said at least one indent being formed with edges to be largely encased by the friction lining formed onto said bearing surface.

In other words, the objects of the invention are achieved with a lining backing plate for a friction lining of a disk brake made up of a backing plate having a bearing surface for a friction lining and the friction lining. In order to improve the transverse strength, i.e., the shear strength, the bearing surface for the friction lining is partially provided with at least one indent whose edges are largely surrounded by the friction lining formed on the bearing surface; in this way the anchoring of a friction lining is improved in an extremely simple but very effective manner, so that the object of the invention is thereby simultaneously realized in a very economical fashion. Here it is essential that through this indent, which can be arranged in the longitudinal and transverse axis of the lining backing plate, a quasi-positively locking connection is produced between the lining backing plate and the friction lining in the direction of the shear forces, which significantly increases the security against a shearing off of the friction lining from the lining backing plate.

A construction is regarded as particularly advantageous in which, for the better anchoring of the friction material, an insert or inset is fastened in the indent, which insert can consist of a wire mesh, expanded or stretched material, or a perforated sheet, and is fastened onto the backing plate by rivets formed from the backing plate. Preferably, the insert is molded flatly onto the bearing surface in a region around the rivets, through a plastic deformation before or during the riveting, in order there to ensure a positively locking connection without play. The outer contour of the insert preferably corresponds essentially to the contour of the indent, so that when shearing stress is placed on the friction lining attached to the insert, the insert can be supported on the edge of the indent, which significantly improves the stability of the overall construction. However, specific embodiments are also conceivable of this type of fastening of inserts, using rivets formed from the backing plate, on backing plates that are not provided with a indent, but are simply of flat, planar construction.

In addition, a specific embodiment of the invention is advantageous in which the vibration characteristic of the lining backing plate is significantly reduced through the installation of selected inserts. In addition, an effective influence on the characteristic frequency, or the vibration characteristic, of the lining backing plate can be exercised through the shape, the material, or the arrangement of the insert, as well as through the number and arrangement of the rivets or the openings and the indent, so that, for example, squealing noises that are otherwise audible in the operation of similar lining backing plates can be constructively excluded.

According to a further preferred specific embodiment of the invention, in the bored holes or openings of a lining backing plate, projections that extend into the open inner cross-section of the openings can be put into place, for the positively locking connection of the friction lining against a withdrawal and a separation of the friction lining from the lining backing plate, so that a reliable anchoring of the friction lining on the lining backing plate is ensured even after a destruction of an adhesive connection. The friction lining, which is applied to a lining backing plate as a viscous mass, penetrates into the openings, and thereby surrounds the projections protruding inwardly into the openings, thus creating, after the hardening of a friction lining, a positively locking connection with the lining backing plate. This type of anchoring is extremely simple and very effective, and can be realized without the attachment of additional anchoring aids, such as glue, or a metal grille welded onto the lining backing plate, so that a very economical achievement of the object of the invention is simultaneously realized. A combination of this type of fastening with riveted-on inserts considerably improves the operational reliability of a disk brake equipped therewith.

Corresponding to a further preferred specific embodiment of the subject matter of the invention, the projections are produced through a stamping process in which a stamp acts on the lining backing plate in the area of an edge of an opening, over a part of the thickness of the lining backing plate, thus producing a projection in the form of a holding claw that extends into the opening. This type of manufacture of one or more such projections can be carried out rapidly and without great technical expense, so that not only is the type of anchoring particularly advantageous, but also the manufacturing of this anchoring in brake pads that are to be produced in large piece counts can be carried out very economically. Here, a particularly advantageous construction is one in which an opening is realized as a circularly cylindrical perforation of the lining backing plate, having three or more projections. The friction lining compound, which is viscous at first, is preferably applied to the opposite side of the lining backing plate, from which the projections have been put into place, so that relatively large holding surfaces, approximately parallel to the surface of the lining backing plate, are provided for the friction lining as an abutment against a withdrawal of the anchoring peg from the opening. However, an application of the friction lining compound can also take place in synchronized fashion on the same side from which the projections have been put into place. In addition, such projections can be put into place at different heights over the depth of an opening, which significantly increases the tensile strength of an anchoring peg.

In addition, for the further improved anchoring of the friction material on a lining backing plate, a variant embodiment is advantageous that has mounting elements formed so as to protrude from the surface of the indent, which can be formed as roll chips, burrs, or projections, which can for example be manufactured using cutting tools or notching i.e., serrating, tools, and around which an applied friction lining compound hardens, so that a multiple positively locking connection of the friction lining with the lining backing plate is achieved.

A specific embodiment of the invention is particularly advantageous in which the openings are situated in a sub-area of the lining backing plate, which is indented towards the rear over a large surface, whereby the resulting element edges and shoulders of the indent additionally secure the formed-on friction lining against shearing off. Due to the pressed-back support surfaces of the friction lining, the absorption of shearing forces between the lining backing plate and the friction lining is significantly improved. At the same time, due to the indent an increasing of the overall thickness of the lining backing plate is achieved, and at the same time its resistance to bending is considerably improved, so that the initial thickness of a lining backing plate can be selected thinner from the outset; this has a positive effect for example on the reduced unsprung masses of a motor vehicle, as well as on the reduced overall mass thereof, but also, in particular with respect to the high piece counts to be manufactured, it has a positive effect to a considerable extent on the greatly reduced material costs, and likewise on a conservation of resources, be it in the production of steel or in the processing.

In accordance with a further preferred specific embodiment of the subject matter of the invention, used in particular for brake lining backing plates of disk brakes of trucks, in order to extend the guiding of the brake backing plate in a brake caliper the backing plate is provided with indented surfaces on its lower side and/or on its lateral end faces. The installation of such indents up to the region of the lateral edges achieves an enlargement of the effective thickness of the lining backing plate in the area of the lateral guide surfaces, which effectively prevents the brake pad from sliding out of the brake caliper when the limit of wear of the brake lining has been exceeded.

Other features which are considered as characteristic for the invention are set forth in the appended claims.

Although the invention is illustrated and described herein as embodied in a lining backing plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a top view of a first lining backing plate;

FIG. 2 is a side view of the lining backing plate according to FIG. 1 with a friction lining;

FIG. 3 is a top view of a second lining backing plate;

FIG. 4 is a sectional side view, taken along the line IV-IV in FIG. 3, of the lining backing plate with a friction lining;

FIG. 5 is an enlarged section of the detail A in FIG. 4;

FIG. 6 is a top view of a third embodiment of the lining backing plate according to the invention;

FIG. 7 is a section side view, taken along the line VII-VII in

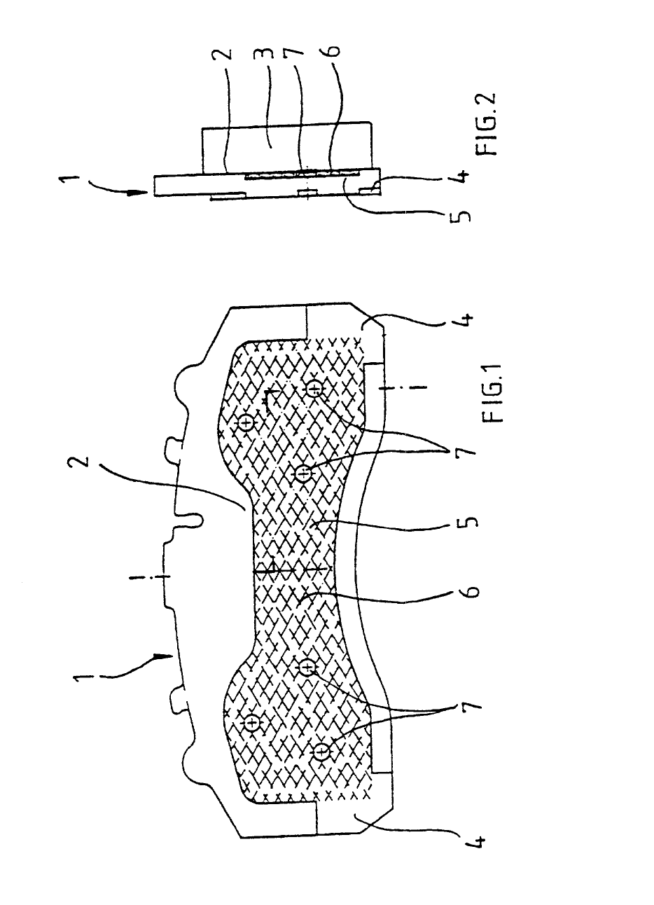

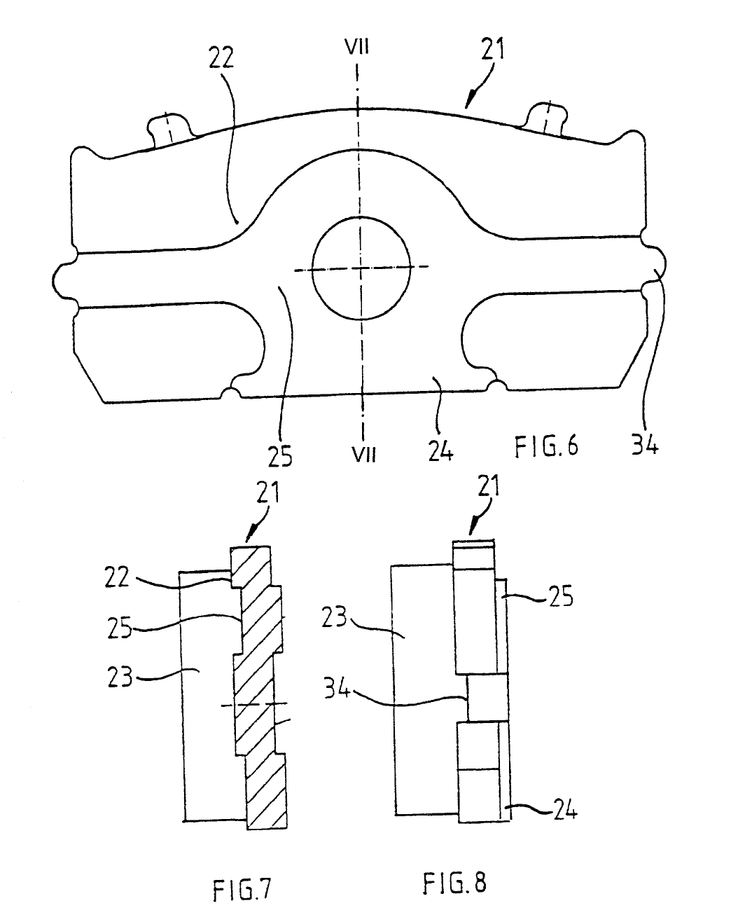

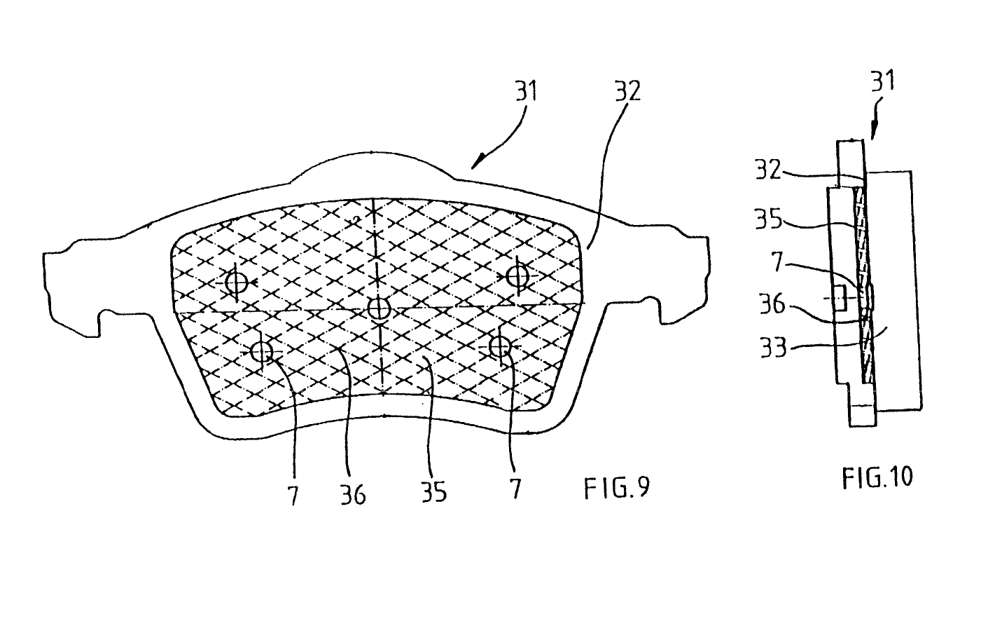

FIG. 6, of the lining backing plate with a friction lining;

FIG. 8 is a side view of the lining backing plate according to FIG. 6 with a friction lining;

FIG. 9 is a top view of a fourth lining backing plate; and

FIG. 10 is a side view of the lining backing plate of FIG. 9, with a friction lining.

### DESCRIPTION OF THE PREFERRED EMBODIMENTS

Referring now to the figures of the drawing in detail, there is shown, in the various views and in a variety of exemplary embodiments, a lining backing plate 1;11;21;31 for a friction lining 3;13;23;33 of a disk brake, made up of a brake disk, a brake caliper having brake pistons, and brake pads, each made up of two such lining backing plates 1;11;21;31. The brake pad is made up of a backing plate having a bearing surface 2;12;22;32 for friction lining 3;13;23;33 and friction lining 3;13;23;33, which is there formed from a hardened compound, and guide or holding surfaces of the backing plate in a brake caliper. In order to improve the shear strength, or transverse strength, at least one indent 5;15;25;35 made in bearing surface 2;12;22;32, whereby a large part of the edges of the indent 5;15;25;35 are surrounded by the friction lining 3;13;23;33 that is formed on the bearing surface 2;12;22;32 of the lining backing plate 1;11;21;31.

Rivets 7 formed out of the backing plate are situated in indent 5; 35 of bearing surface 2; 32, thereby fixing an insert 6; 36 on the backing plate, whereby the outer contour of insert 6; 36 matches almost completely the shape of the inner contour of indent 5; 35. Here, insert 6; 36 is manufactured from a stretched material, but however can also consist of a wire mesh or a perforated plate. In a manner that is not shown in the drawings but is likewise advantageous, such rivets can likewise be fashioned on the non-indented region of bearing surface 2; 12; 22; 32.

The insert 6; 36 is fixed on the bearing surface 2; 32 through a plastic deformation of rivets 7. In a region around rivets 7, insert 6; 36 is reshaped flatly onto bearing surface 2; 32 before or during the riveting, in order to ensure an optimal positively locking connection without play. For quality testing in the manufacturing of brake pads, this fastening can be tested simply and completely even without the use of destructive tests.

The lining, which is to be applied to lining backing plate 1; 31 as a viscous compound, and which later hardens to form a hard friction layer 3; 33, surrounds insert 6; 36 according to FIGS. 2 and 10, and is fixed on lining backing plate 1; 31 in this way.

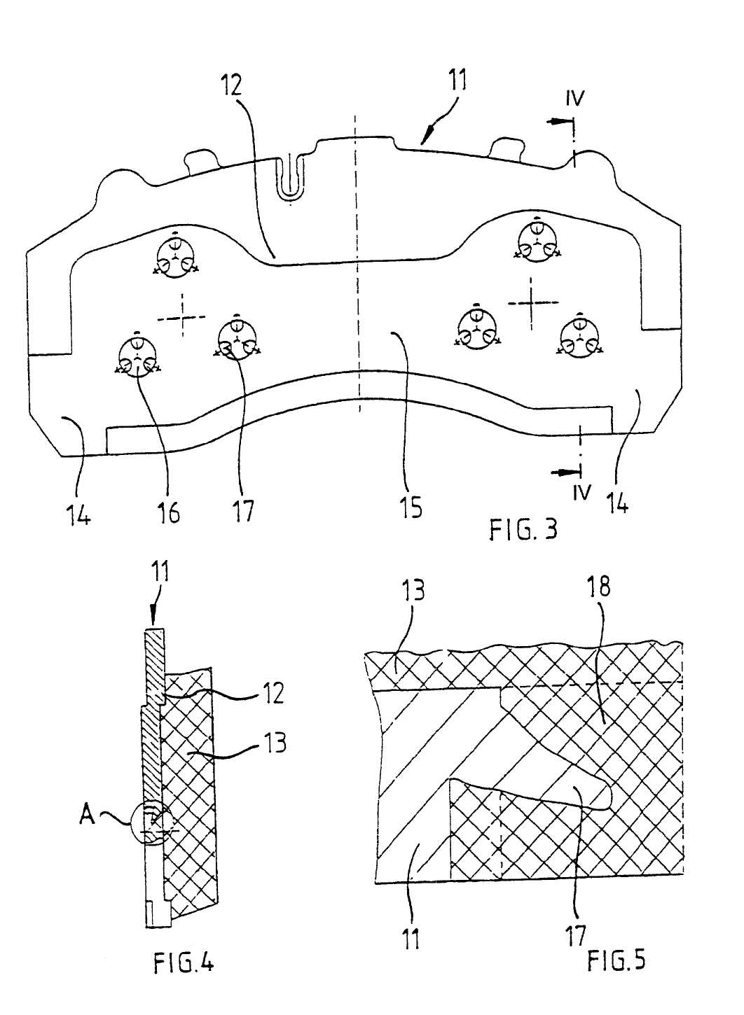

In contrast, lining backing plate 11 according to FIGS. 3 to 5 has six cylindrical openings 16, into each of which three projections 17, produced in a stamping process, protrude, in order to anchor the friction lining compound, which is applied onto lining backing plate 11 and into openings 16 in a pulpy state and is subsequently hardened, on the surface of lining backing plate 7 in positively locking fashion against a withdrawal, by means of anchoring pegs 18 formed there. Projections 17 consist of formed parts made via a stamping process in the region of the edge and over a part of the depth of openings 16, in the form of holding claws, whereby such projections 17 from the side of lining backing plate 11 opposite friction lining 13 and in each opening 16 three projections are formed with equal height, or also with differing height. On a lining backing plate 21 according to FIGS. 6 to 8, a friction lining 23 is glued in a conventional manner, but is optimally secured against shearing off by indent 25.

In all other specific embodiments as well, shear forces occurring during operation between a friction lining 3; 13; 23; 33 and a lining backing plate 1; 11; 21; 31 are accordingly absorbed not only by rivets 7 thereof or by anchoring pegs 18, but also, and even in the complete absence of such fastening means, are supported by the side surfaces of indent 5; 15; 25; 35.

Lining backing plate 1; 11; 21; 31 is, as shown in the figures, equipped with additional indents 4; 14; 24; 34 in the side regions, the lower corner regions, or also in the region of a lower lateral edge, the end faces of these additional indents being fashioned as extended guide surfaces in a brake caliper, which, given highly or excessively worn brake linings, act as a safety measure against slipping out for lining backing plate 1;11;21;31.

Through a previously determined type and situation of insert 6;36 and/or of rivets 7 and/or of indent 4;5; 14;15; 24;25; 34;35 and/or of openings 16, the vibration characteristic of lining backing plate 1;11;12; 21; 31 can be matched to a desired characteristic, whereby this optimization can be determined by computer simulation and/or trials.

I claim:

1. A backing plate for a friction lining of a disk brake pad, comprising:
a sheet-metal plate having a bearing surface for supporting the friction lining formed thereon from a hardened compound, and having guide and holding surfaces for mounting in a brake caliper of a disk brake;
said sheet-metal plate having at least one indent formed therein, for improving a shear strength of the friction lining on said bearing surface, said at least one indent being formed with edges to be largely encased by the friction lining formed onto said bearing surface.

2. The backing plate according to claim 1, which comprises an insert fastened in said indent for improved anchoring of the friction material.

3. The backing plate according to claim 2, wherein said insert is a structure selected from the group consisting of a wire grille, expanded material, expanded metal mesh, and a perforated plate, fastened thereon by rivets formed from said sheet-metal plate.

4. The backing plate according to claim 2, which comprises an insert for improved anchoring of the friction material fastened on a substantially flat backing plate having rivets formed therefrom.

5. The backing plate according to claim 2, wherein said insert is molded flat onto said bearing surface in a region around said rivets, prior to riveting.

6. The backing plate according to claim 1, wherein said sheet-metal plate has at least one opening formed in said bearing surface, and wherein an anchoring peg of a friction lining formed on said bearing surface is stabilized in said at least one opening, and wherein at least one projection extends in said opening into an open inner cross-section thereof, said projection holding said anchoring peg in a positive form lock, and preventing a withdrawal and separation of the friction lining from said sheet-metal plate.

7. The backing plate according to claim 6, wherein said projection is a formed part, in the form of a holding claw, produced by a stamping process at an edge, and made over a part of the depth of said at least one opening.

8. The backing plate according to claim 6, wherein said projection is formed into said sheet-metal plate from a side thereof opposite the friction lining.

9. The backing plate according to claim 6, wherein said projection is one of three projections formed in each said opening.

10. The backing plate according to claim 6, wherein said opening is formed over a depth thereof with a plurality of projections with different heights.

11. The backing plate according to claim 1, wherein a surface of said indent is formed with protruding holding elements for improved anchoring of the friction material.

12. The backing plate according to claim 11, wherein said holding elements are selected from the group consisting of roll chips, burrs, and projections.

13. The backing plate according to claim 11, wherein said holding elements are produced with a process selected from the group consisting of cutting and notch.

14. The backing plate according to claim 1, wherein, to ensure a sufficient guiding of the backing plate in a brake caliper, beyond acceptable wear of the friction lining, said sheet-metal plate is formed with indents extending in a direction of said sheet-metal plate opposite to the friction lining.

15. The backing plate according to claim 14, wherein said indents are formed on at least one of a lower side and at regions of lateral end faces of said sheet-metal plate.

16. The backing plate according to claim 1, wherein at least one element thereof selected from the group of inserts, rivets, said indent, and openings formed therein, is configured to match a vibration characteristic of the backing plate to a desired characteristic.

17. In a disk brake having a brake disk, a brake caliper with brake pistons, and brake pads, each formed of a lining backing plate formed of a sheet-metal plate having a bearing surface for a friction lining, and the friction lining formed from a hardened compound, and wherein the sheet-metal plate is formed with guide surfaces or holding surfaces for mounting in the brake caliper, the improvement which comprises, for improving a shear strength of the brake pad, the bearing surface for the friction lining has at least one indent formed therein, and a large part of the edges of the indent are surrounded by the friction lining formed onto the bearing surface of the sheet-metal plate.
